(19) United States
(12) Patent Application Publication
(10) Pub. No.: US 2003/0070065 A1
(43) Pub. Date: Apr. 10, 2003

(54) Suspending to nonvolatile storage

(76) Inventor: Bruce L. Fleming, Phoenix, AZ (US)

Correspondence Address: TROP PRUNER & HU, PC, 8554 KATY FREEWAY, SUITE 100, HOUSTON, TX, 77024, US

(21) Appl. No.: 10/264,548

(22) Filed: Oct. 4, 2002

Related U.S. Application Data
(63) Continuation of application No. 09/283,334, filed on Mar. 31, 1999.

(51) Int. Cl. G06F 15/177

(52) U.S. Cl. 713/2

(57) ABSTRACT

A system may, in some embodiments, achieve reduced power consumption and prompt return to an operating condition even where conventional storage media, such as hard disk drives, are not available. The system may enter a suspend to random access memory state with reduced power consumption in response to a user command. In response to a time out of a timer, in one embodiment of the present invention, the system may suspend to a power off state by transferring information about the context of the system to non-volatile storage. When it is desired to resume the system, the system can return to the state in which it last existed using the software and hardware settings and configurations that were stored when entering the reduced power consumption state. In this way, reduced power consumption can be obtained without losing the system context upon resumption of normal operations.

### BACKGROUND

This invention relates generally to processor-based systems and in particular embodiments to such systems which operate with limited storage capabilities.

A large number of processor-based systems operate with relatively limited storage capabilities for a number of reasons. In some cases these systems may be battery powered. In this case, it may be advantageous to operate without hard disk drives which may use a relatively large amount of power. Examples of such systems include in car personal computer systems, personal digital assistants (PDAs), digital cameras, appliances, cellular telephones, and point-of-sale terminals.

In other cases, limited storage may be provided to achieve relatively low cost. For example, in set top personal computers, a hard disk drive may not be used in order to reduce the cost of the system, and to simplify its operation. Set top personal computer systems may use a television receiver as a display device and may be useful in providing conventional computer functions such as Internet access with the ability to provide computerized control of television program selection.

Some processor-based systems have a reduced power mode called “suspend to random access memory” (STR). Currently this mode is entered after a period of inactivity. However, the STR mode still may consume power which may become significant over time. Thus, even though the device is maintained in a relatively inactive state, power is applied to the electronic circuitry, resulting in continued power consumption.

Normally the alternative is simply to turn the system off. However, this means that once the user is ready to use the system, the system must be re-booted. Re-booting takes time. In addition, the user loses all the information associated with the software which was active prior to turning the system off.

Thus, there is a continuing need for ways to improve performance of processor-based systems including, but not limited to, those which do not include hard disk drive storage.

### SUMMARY

In accordance with one embodiment, a method of operating a processor-based system includes receiving an indication in connection with the system entering a reduced power consumption state. The method also includes automatically storing in non-volatile storage an image of the system that enables the system to be reinitialized without rebooting.

### BRIEF DESCRIPTION OF THE DRAWINGS

FIG. 1 is a state diagram for one embodiment of the present invention;

FIG. 2 is a flow chart for the embodiment shown in FIG. 1;

FIG. 3 is a block diagram showing one system for implementing the present invention;

FIG. 4 is a diagrammatic depiction of the operating image in accordance with one embodiment; and

FIG. 5 is a schematic depiction of how an image is created and utilized in one embodiment.

### DETAILED DESCRIPTION

Referring to FIG. 1, a processor-based system may initially be booted from non-volatile storage 12 as indicated in state 10. This corresponds to a power on reset operation and eventually results in operation of an operating system as indicated at 14. The processor-based system may have a reduced storage capability such as the absence of a hard disk drive. Systems of this type may use real time operating systems (RTOS). They may also use the Windows® CE operating system.

When the user wishes to reduce power consumption, the user can cause the device to enter a suspend to random access memory(STR) state 16. In response to user activity, such as providing input signals through input/output devices, such as a keyboard, the system returns from the STR state 16 to normal operation of the operating system, as indicated at 14.

After a period of inactivity in the STR state, which may be a predetermined period, the system may transition to a suspend to a semiconductor non-volatile storage (STN) state 18. In this state, information about the current software settings and system information is stored in non-volatile storage. In the STN state, power consumption may be reduced or eliminated (by turning the power off). In response to user action, the system can resume the operating system 14 without going through all the steps necessary in a cold boot process. In addition, it may resume (without rebooting) to the state the system was in prior to entering the STR state. This may include all of the system configuration settings as well as the configuration of any software, such as application programs, that were operating.

The system may transition from the STN state 18 to normal operation of the operating system 14 using an image of the operating system which was stored when the system transitioned from the state 14 to the state 16. This means that not only can time be saved by resuming from STN state 18, but also the information about the ongoing activities of the system may be immediately resumed as well. This may be a considerable advantage compared to effectively power cycling the system off and on to save power. Processor power cycling results in losing all the available states of the system and requiring a cold boot process to return to full operation. Thus, by storing an image of the system at the time of the transition to the STR state 16 and transferring that image to non-volatile storage when transitioning to the state 18, faster booting and retention of software and system information may be achieved.

Thus, while the illustrated embodiment involves a system with limited storage, using for example Windows® CE as its operation system, aspects of the present invention may be used in other processor-based systems, including those with conventional storage capabilities. For example, such systems may automatically store an image of the operating system in connection with entering a reduced power consumption mode. For example, a system compliant with the Advanced Configuration and Power Interface (ACPI) Specification (Revision 1.0, Dec. 22, 1996), may automatically store the image when entering the D3 reduced power consumption state, in one example.

The image may include information such as the configuration settings of currently operating software, information from registers that are active at the time of transition, and other information which enables the system to return, substantially unaffected, to the exact hardware and software state that the system was in prior to transitioning to the STR state 16 without rebooting.

The base operating system image may be a stored virtual image of the operating system before entering a reduced power consumption mode. The image captures a system configuration for the computer system with the existing hardware and software configuration parameters. The operating system image may, for example, include register settings, device settings, base memory page files and the like. In short, it includes everything that is loaded into memory at run time including dedicated applications and a user shell

Basically, the image may include all the necessary parameters for an operating system to operate an actual computer configuration. It corresponds to the information about the registers and memory which is developed during the operating system bootup sequence for the predefined base computer configuration. Thus, the image is effectively a virtual image of the operating system after bootup with the predefined characteristics, analogous to a configuration snapshot. The image includes information about the memory and registers of system after bootup time.

In one embodiment of the invention, the system may be implemented using a driver stored with the operating system and another portion of software stored in a boot loader that may also load the operating system and provide power management. The boot loader automatically runs when the computer is powered on, performs hardware tests, and loads the operating system and passes control to a loader program that then loads the operating system.

Referring now to FIG. 2, assuming the system is fully operational, the operating system is running and application program is currently active, the software 20 checks at diamond 22 whether the user has commanded that the system enter the STR state 16. If so, a suspend operation is initiated and a timer is started as indicated in block 24.

Next, the operating system including the device driver context is saved as indicated in block 26 so that the system may resume at the exact state which it was in prior to powering down. The system then enters the STR state 16 as indicated in block 28.

In the STR state, a timer is initialized and a count started. If the timer has not expired as determined at diamond 30, a check at diamond 32 determines whether there is user action. If not, the system simply stays in the STR state 16. If the timer has not expired, and there is user action which is detected at diamond 32, the system may resume from the stored RAM information (see block 33) and the software 20 ends.

Otherwise, if the timer has in fact expired, the system may enter the STN state 18 as indicated in block 34. In the STN state 18, the RAM image which was saved in block 26 is transferred to non-volatile storage as indicated in block 36. The non-volatile storage may be a flash memory in one embodiment of the present invention. If user action occurs during the storage process as determined at diamond 38, the system immediately boots from the STR image (block 40) and the flow 20 ends. If there is no user action, the system continues to store the RAM image in the non-volatile memory until the whole image is saved as determined in diamond 42.

After the image is saved, the system powers down and may in fact power down to a no power consumption state as indicated in block 44. If user action is detected as indicated as diamond 46, the system moves data from the non-volatile storage to random access memory (RAM) system memory as indicated in block 48. For example, the user may initiate a power on reset. Then the system returns to the operating system at the point when the STR state was entered using the stored context image (block 50).

In this way, the system can achieve desirable power conservation while allowing the system to be operated quickly and efficiently from a variety of power consumption states. The system may be returned from the no power consumption (“power off”) state using a resume operation without necessitating a full rebooting and may return to its last known state prior to beginning a reduced power state. The resume operation may be expedited because some of the normal operating system bootup operation may be unnecessary because the information that would have been developed in bootup is already available from the stored image. Especially, where the instructions are stored using low level functions to encode the file, the file may be read quickly.

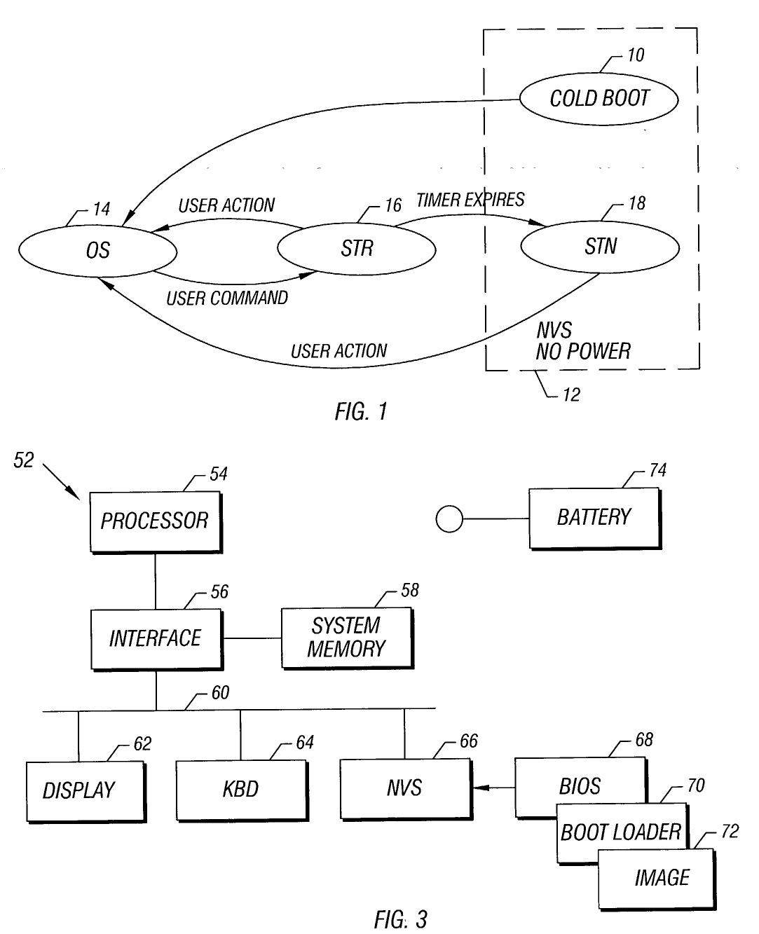

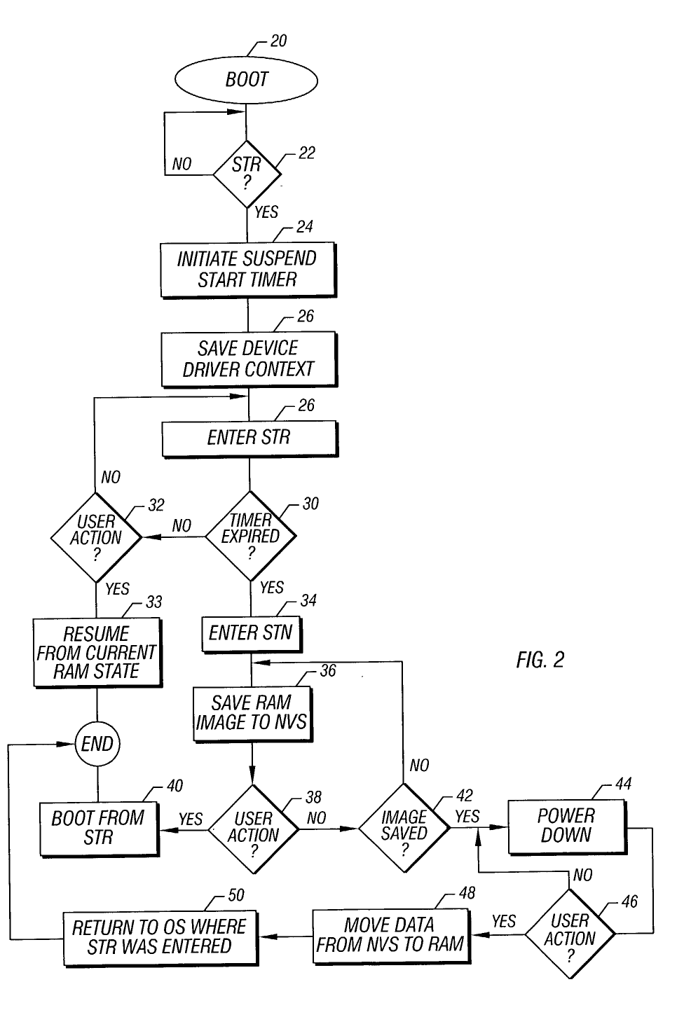

Referring next to FIG. 3, a processor-based system, in accordance with one embodiment of the invention, uses a semiconductor non-volatile storage such as flash memory as opposed to a hard disk drive storage. The system 52 may be any one of a variety of systems which may use closed operating systems such as personal digital assistants, point-of-sale terminals, and in car personal computers as just a few examples. While the illustrated system uses a battery 74, systems which use conventional alternating current power sources may be used as well including those used as set top computer systems.

The processor 54 may be coupled to an interface 56 which interfaces between system memory 58 and a local bus 60. The system memory may provide the random access memory (RAM) for the STR state storage. The local bus 60 may be coupled to a display 62 which in one embodiment of the present invention may be a liquid crystal display. The local bus 60 may also be coupled to a keyboard 64 and a non-volatile storage 66. The non-volatile storage may store a basic input/output system 68, and a boot loader 70. When the system is in the STN state 18, an image 72 of the configuration of the system at the time the system was powered down to the STR state may also be stored in the non-volatile storage 68. The image 72 may be transferred to the system memory 58 upon return to normal operating condition from a powered down or no power state.

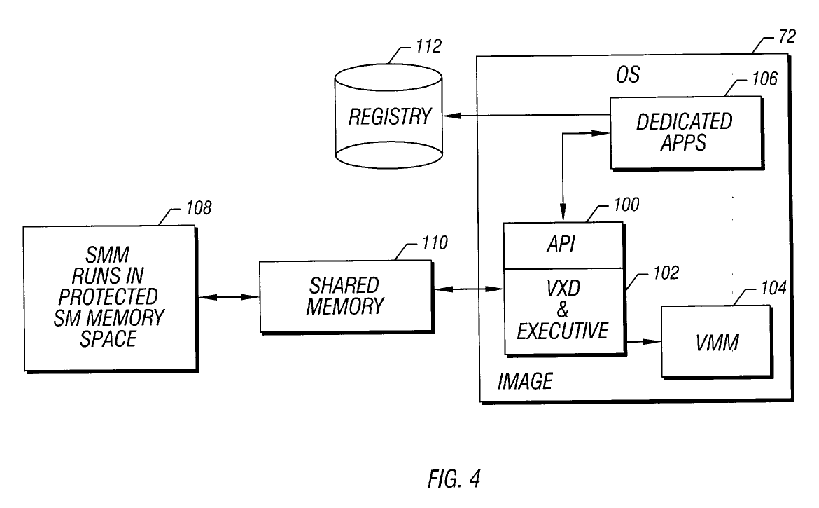

Referring now to FIG. 4, the image 72 may include an application program interface (API) 100 and VxD and executive 102. The API 100 may, for example, be the device I/O control API provided with the Windows® 32 bit operating systems. The API 100 initiates the VxD 102, causing the VxD 102 to create an image 72.

The virtual machine manager (VMM) 104 is a manager available on 32 bit Windows® operating systems. The VxD 102 can query the VMM 104 for application status information.

The registry 112 is a status database, such as the Windows® registry. The registry 112 is not part of the image 72 but it provides the latest information on hardware and software configurations. When the system is restored, the latest settings can be recalled using information obtained by the dedicated applications 106 from the registry 112.

The shared memory 110 allows the image 76 to communicate with the system management mode (SMM) memory 108. As indicated in FIG. 4, the SMM runs in protected system management memory space. This space exists at ring 0 and is very protected. Therefore, the VxD and the executive 102 may not directly access the SMM memory 108. A shared memory 110 is accessed by the VxD 102. Advantageously, the shared memory 110 may be unknown to the operating system, such as the Windows® CE operating system. When the shared memory 100 is not mapped to the operating system, the operating system cannot access it. However, the VxD 102 can access the memory 110 to allow communications between the system management mode memory 108 and the VxD and executive 102.

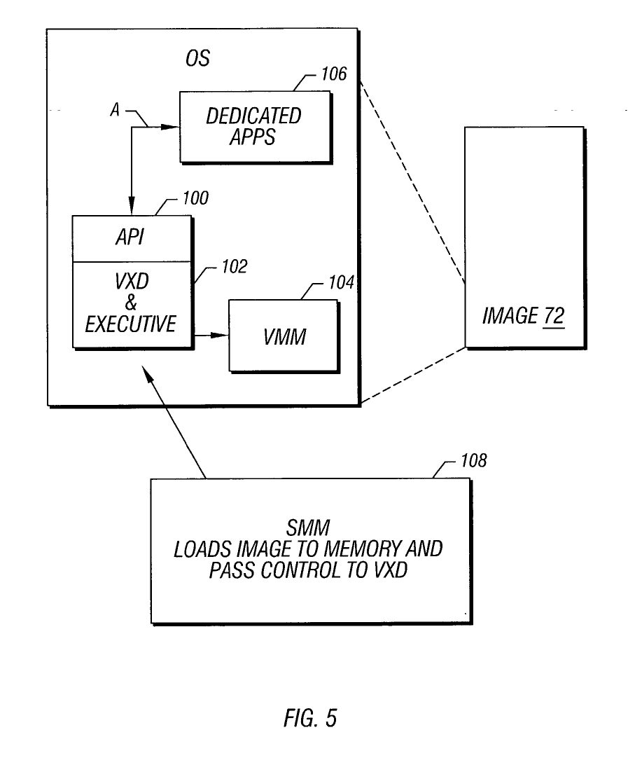

Referring now to FIG. 5, the image is created by the executive 102. The VxD and executive 102 are called at a point where the dedicated applications and the user shell are loaded and ready to query the VxD API 100 for a wakeup signal. The image may include the complete memory state of the machine including hardware registers of the processor and devices, together with some system files. The image may be created by making the same VxD call, for example, when the system is entering the STR state.

When it is desired to restore the image, the SMM loads the image into system memory 58 and passes control to the VxD 102 as indicated at block 108. The VxD 102 completes the restore and then return from the entry in the API 100 where it was called. The dedicated applications 106 are then ready for use and allowed to continue to run. They each query the VxD and executive 102 through the API 100, as indicated by the arrows “A”, learn that they are awake and retrieve their configuration states. Thus, to the user the dedicated applications appear to run seamlessly, appearing virtually uninterrupted in the same state they were in prior to enter the STR state.

If the image is stored in non-volatile storage 66, it is first transferred to system memory 58. From there, the image is recovered as described above.

In effect, the VxD is able to supplement or extend the functionalities of the kernel level of the Windows® operating system. Of course this same functionality can also be written into the operating system kernel if one has access to the operating system kernel. By using the VxD, a desired functionality can be added to existing operating system kernels.

The system may be operated so that it is booted only one time in some embodiments. Thereafter, even after being turned off, the system initializes using the stored image.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed:

1. A method of operating a processor-based system comprising:
receiving an indication in connection with the system entering a reduced power consumption state; and
automatically storing in non-volatile storage an image of said system that enables said system to be re-initialized without rebooting.

2. The method of claim 1 wherein automatically storing includes storing an image of the system when the system is suspended to a reduced power consumption state.

3. The method of claim 2 further including resuming the system from a power off state and restoring said system to the stored image.

4. The method of claim 1 further including starting a timer when the system suspends to a reduced power consumption state and if a predetermined time expires, automatically suspending the system to a power off state.

5. The method of claim 4 further including causing the system to return to a normal power consumption state, when suspended to a reduced power consumption state, in response to user action.

6. The method of claim 1 further including resuming the system from the power off state in response to user action.

7. The method of claim 6 further including transferring said image from non-volatile storage to system memory.

8. The method of claim 1 wherein if user action occurs during the act of storing to non-volatile storage, resuming the system to the normal power consumption mode.

9. The method of claim 3 wherein resuming the system from the power off state includes moving information from the non-volatile storage to system memory.

10. The method of claim 9 including automatically storing said image in system memory before entering a reduced power consumption state.

11. The method of claim 10 further including resuming to a normal power consumption from the point where the reduced power consumption state was entered.

12. The method of claim 11 further including automatically transferring the image stored in system memory to non-volatile storage after receiving said indication.

13. The method of claim 2 wherein suspending to a reduced power consumption state includes storing information sufficient to return to the then current state of an application program.

14. The method of claim 1 further including entering said reduced power consumption state in response to a user command.

15. An article comprising a medium for storing instructions that cause a processor-based system to:
store information about the system in system memory;
suspend to a reduced power consumption state;
after a period of activity, store said information in a semiconductor non-volatile storage; and
suspend to a power off state.

16. The article of claim 15 further including instructions that cause a processor-based system to store an image of the system when it was suspended to a reduced power consumption state.

17. The article of claim 16 further including instructions that cause a processor-based system to resume the system from the power off state and restore said system to the stored image.

18. The article of claim 15 further including instructions that cause a processor-based system to start a timer when the system suspends to a reduced power consumption state and if a predetermined time expires, suspend the system to the power off state.

19. The article of claim 15 including instructions that cause a processor-based system to return the system to a normal power consumption state when suspended to a reduced power consumption state in response to user action.

20. The article of claim 15 including instructions that cause a processor-based system to resume the system from the power off state in response to user action.

21. The article of claim 15 including instructions that cause a processor-based system to transfer said information from non-volatile storage to said random access memory.

22. The article of claim 15 including instructions that cause a processor-based system to, if user action occurs during the process of saving a non-volatile storage, resume the system to the normal power consumption mode.

23. The article of claim 15 including instructions that cause a processor-based system to move information from the non-volatile storage to system memory and resume from the point where the reduced power consumption state was entered.

24. The article of claim 15 including instructions that cause a processor-based system to store information sufficient to return to the then current state of an application program.

25. The article of claim 15 including storing instructions that cause a processor-based system to suspend said system to reduced power consumption state in response to a user command.

26. A processor-based system comprising:
a processor;
a random access memory coupled to said processor and adapted to store information about the system when said system is in a reduced power consumption state; and
a nonvolatile storage coupled to said processor, said storage adapted to automatically store said information before the system enters a power off state.

27. The system of claim 26 wherein said system is adapted to only boot the first time the system in powered on.

28. The system of claim 26 wherein said non-volatile storage is a semiconductor non-volatile storage.

29. The system of claim 28 wherein said storage is flash memory.

30. The system of claim 26 adapted to automatically develop an image of the system and to automatically store said image before powering off.
